(19) United States
(12) Patent Application Publication
(10) Pub. No.: US 2012/0018243 A1
(43) Pub. Date: Jan. 26, 2012

(54) HEADPHONES

(75) Inventor: Takayuki MIYAZAWA, Yokohama-Ken (JP)

(73) Assignee: VICTOR COMPANY OF JAPAN, LTD., Yokohama-Shi (JP)

(21) Appl. No.: 13/182,935

(22) Filed: Jul. 14, 2011

(30) Foreign Application Priority Data
Jul. 22, 2010 (JP) JP 2010-164707

(51) Int. Cl. G10K 11/00

(52) U.S. Cl. 181/126

(57) ABSTRACT

In a headphone set, a speaker is enclosed in a housing. A cord is connected to the speaker at one end and running to the outside of the housing at another end through a pulling-out portion of the housing. The cord is inserted into a bushing at the pulling-out portion. An outer-shape expansion portion is fixed to the cord and located between the speaker and the bushing. The outer-shape expansion portion expands the outer shape of the cord. A concavity is provided to the bushing at one end of the bushing closer to the speaker. At least a portion of the outer-shape expansion portion is put in the concavity.

### CROSS-REFERENCE TO RELATED APPLICATIONS

This application is based on and claims the benefit of priority from the prior Japanese Patent Application No. 2010-164707 filed on Jul. 22 2010, the entire contents of which are incorporated herein by reference.

### BACKGROUND OF THE INVENTION

The present invention relates to headphones.

In headphones, one end of a cord is connected to a speaker unit and the other end thereof runs to the outside of a housing through a flexible bushing. The cord is provided with an outer-shape expansion portion (such as a knot tied in the cord) located inside the housing.

Such structure is applied to a variety of headphones, such as, an overhead type having a head band to be supported on the head, and an inner-ear type to be inserted into the auricle.

With this structure, the cord is protected from being detached from the housing because of a larger size of the knot, the outer-shape expansion portion, than the other portion of the cord. Moreover, the cord exhibits high durability because it runs to the outside of the housing through the flexible bushing.

The outer-shape expansion portion (the knot) is provided between the bushing and the speaker unit in the housing.

When the outer-shape expansion portion is located closer to the bushing, the length of the cord to be pulled from outside becomes shorter, thus exhibiting high quality.

Moreover, the outer-shape expansion portion protects an end of the cord soldered to the speaker unit from external force, thus also exhibiting high quality.

Therefore, the outer-shape expansion portion requires to be installed in the housing and located closer to the bushing.

It is preferable for the speaker unit to be larger for outputting sounds of higher quality. A larger speaker unit is equipped with a larger diaphragm, a larger magnet, etc.

However, there is a demand for more compact headphones with a smaller housing, for use in, particularly, outdoors.

Therefore, the housing requires the space enough for installing a large speaker unit and a knot of a cord, hence posing a difficulty in compactness of headphones.

### SUMMARY OF THE INVENTION

A purpose of the present invention is to provide a headphone set having a compact housing with a cord having an outer-shape expansion portion provided in the housing, the cord being protected from being detached from a bushing and exhibiting high durability.

The present invention provides a headphone set comprising: a housing having a pulling-out portion; a speaker enclosed in the housing; a cord having a first end and an opposing second end, the first end being connected to the speaker, the second end being running to the outside of the housing through the pulling-out portion; a bushing formed into a tube having a first through hole, the bushing supporting the cord in a way that the cord is inserted into the first through hole at the pulling-out portion; an outer-shape expansion portion fixed to the cord and located between the speaker and the bushing, the outer-shape expansion portion expanding the outer shape of the cord; and a concavity provided to the bushing at one end of the bushing closer to the speaker, at least a portion of the outer-shape expansion portion being put in the concavity.

### BRIEF DESCRIPTION OF DRAWINGS

FIG. 1 is a perspective view of the appearance of a headphone set, an embodiment according to the present invention;

FIG. 2 is a perspective view of the appearance of a main unit of the headphone set, the embodiment according to the present invention;

FIG. 3 is an exploded view of the main unit shown in FIG. 2;

FIG. 4 is a three-view drawing that illustrates one component of the main unit;

FIG. 5 is a three-view drawing that illustrates another component of the main unit;

FIG. 6 is a perspective sectional view of an ornament ring taken on line S1-S1 of FIG. 4;

FIG. 7 is a sectional view of the main unit taken on line S2-S2 of FIG. 2;

FIG. 8 is a perspective view of the main unit, without a cover; and

FIG. 9 is a perspective sectional view of the main unit taken on line S3-S3 of FIG. 7.

### DETAILED DESCRIPTION OF PREFERRED EMBODIMENT

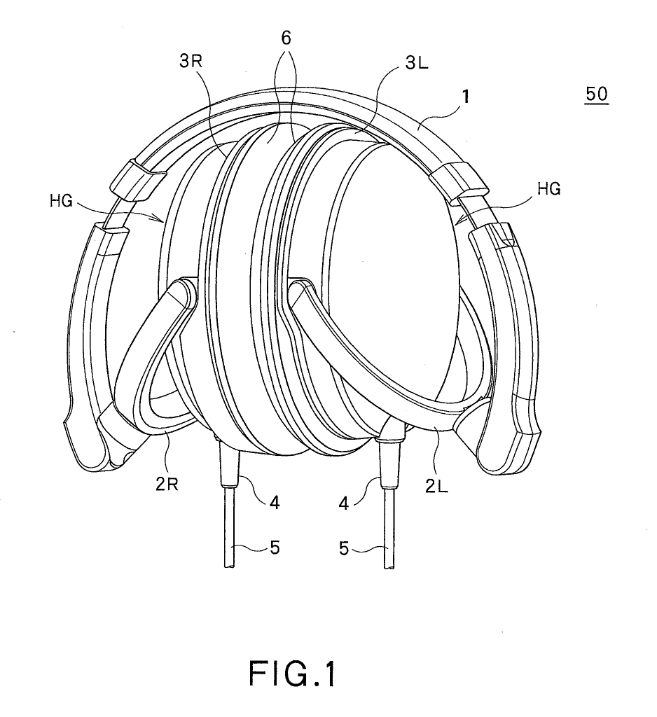

A preferred embodiment according to the present invention will be described with reference to FIGS. 1 to 9.

FIG. 1 is a perspective view of the appearance of a headphone set 50, an embodiment according to the present invention.

The headphone set 50 is an overhead type, equipped with a head band 1, roughly-U-shaped hangers 2L and 2R connected to both ends of the head band 1, and main units 3L and 3R supported by the hangers 2L and 2R, respectively.

The headphone set 50 has two modes: a used mode and a non-used mode in which the headphone set 50 is folded. FIG. 1 shows the non-used mode.

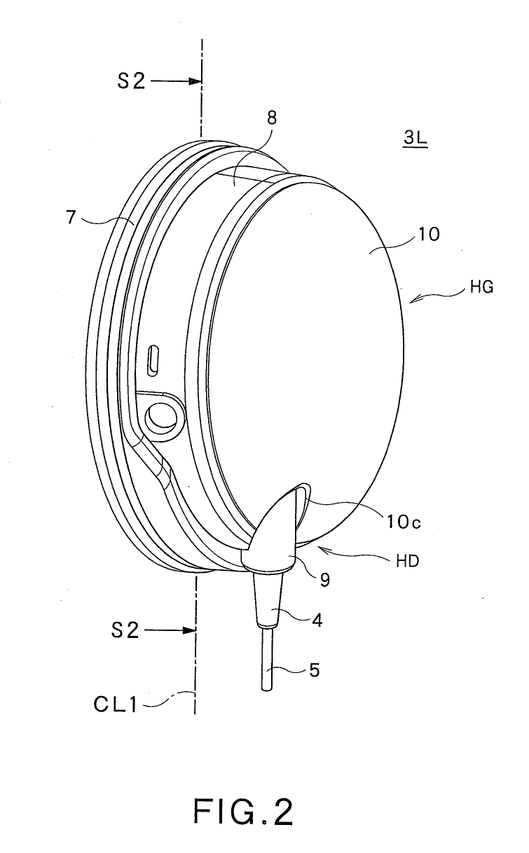

A cord 5 is running from each of the main units 3L and 3R, through a bushing 4. The position from which the cord 5 is running is indicated with a cord-running section HD in FIG. 2. An ear pad 6 is detachably attached to each of the main units 3L and 3R.

The main unit 3L will be explained next. The main unit 3L for the left ear and the main unit 3R for the right ear have a shape of almost plane symmetry. The explanation of the main unit 3R is thus omitted.

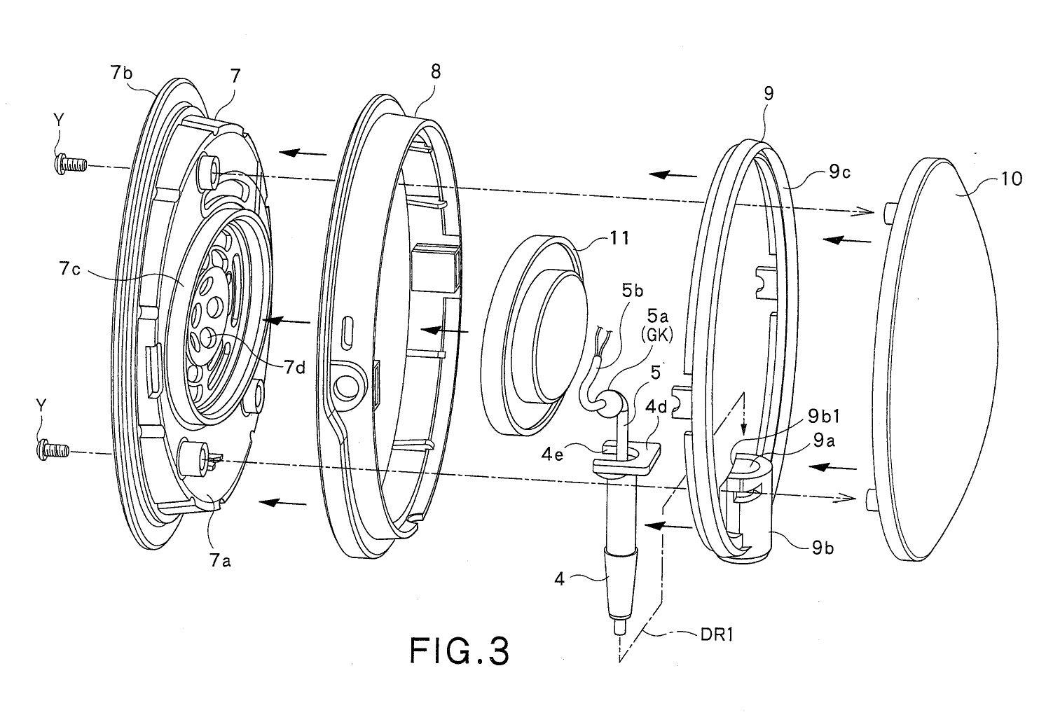

FIG. 2 is a perspective view of the appearance of the main unit 3L, without the ear pad 6 (detached therefrom). FIG. 3 is an exploded view of the main unit 3L shown in FIG. 2.

As shown in FIGS. 2 and 3, the main unit 3L has a base 7, a ring base 8, an ornament ring 9, and a cover 10. Moreover, the main unit 3L has a speaker unit 11 attached to the base 7 and a cylindrical bushing 4 attached to the ornament ring 9. A cord 5 is inserted into the bushing 4.

A case that consists of the base 7, the ring base 8, the ornament ring 9, and the cover 10 is referred to as a housing HG, hereinafter, as shown in FIG. 2.

The speaker unit 11 is installed in the housing HG and the bushing 4 is exposed to the outside of the housing HG.

The base 7 has an oval baffle board 7a having a longitudinal axis CL1 (FIG. 2), an annular flange 7b connected to the edge of the baffle board 7a and protruding outwardly in the direction of diameter for the ear pad 6 to be attached thereto, an annual rib 7c that stands on the baffle board 7a, and a plurality of sound output holes 7d provided on the baffle board 7a and surrounded by the rib 7c. The surface of the baffle board 7a is inclined to the plane including the flange 7b by a predetermined angle.

The ring base 8 is a roughly oval ring that corresponds to the shape of the base 7 so that the former can be attached to the latter to surround the baffle board 7a.

The speaker unit 11 is fixed to the base 7 by an adhesive so as to be placed inside the rib 7c of the base 7. The sounds emitted by the speaker unit 11 are given off to the outside through the sound output holes 7d.

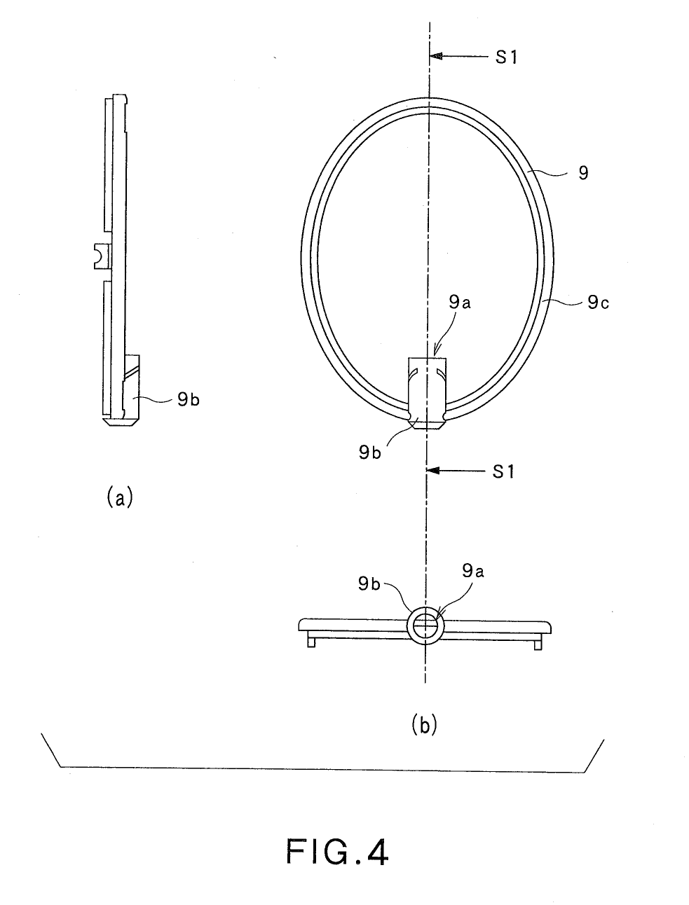

The ornament ring 9 will be explained with reference to FIG. 3 and FIG. 4 that is a three-view drawing.

The ornament ring 9 has a tube 9b having a through hole 9a (a pulling-out portion for the cord 5) and an oval ring 9c that corresponds to the outer shape of the base 7 and the ring base 8.

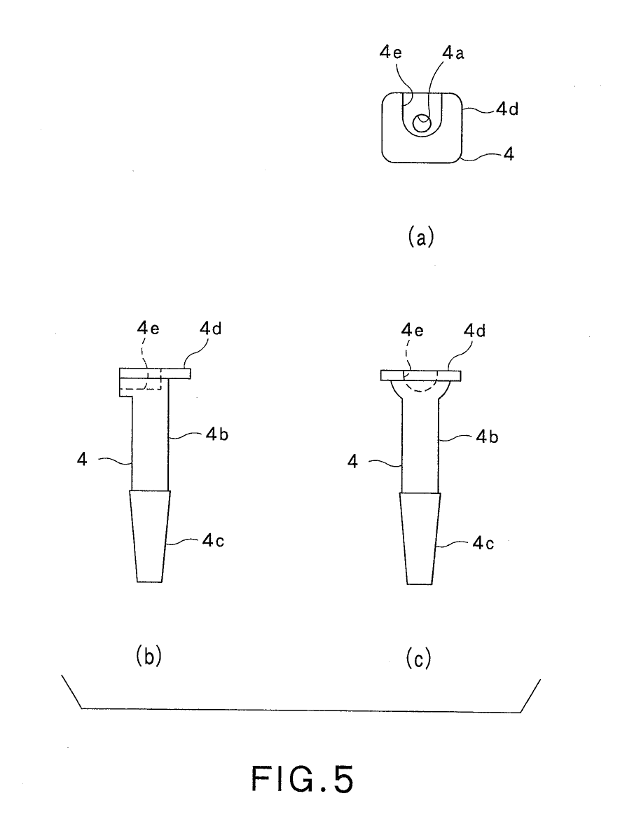

The bushing 4 will be explained with reference to FIG. 3 and FIG. 5 that is a three-view drawing.

The bushing 4 has a tube 4b having a through hole 4a, a tapered tube 4c connected to one end of the tube 4b, and a rectangular flange 4d formed at the other end of the tube 4b. A concavity 4e is formed at the other end of the tube 4b, that is curved in the flange 4d.

As shown in FIG. 3, the bushing 4 is inserted into the through hole 9a of the ornament ring 9 from the top of the tapered tube 4c of the bushing 4 in a direction of an arrow DR1. The cord 5 is then inserted into the through hole 4a of the bushing 4 so that the cord 5 is supported by the bushing 4.

Illustrated in FIG. 3 is that the cord 5 has been inserted into the through hole 4a of the bushing 4 before the bushing 4 is inserted into the through hole 9a of the ornament ring 9.

As shown in FIG. 3, the cord 5 is provided with an outer-shape expansion portion GK that expands the outer shape of the cord 5. In this embodiment, the outer-shape expansion portion GK is a knot 5a. The knot 5a has a larger size than the smallest diameter of the through hole 4a of the bushing 4 so that the knot 5a cannot be inserted into the through hole 4a. Therefore, the outer-shape expansion portion GK (the knot 5a) prevents the cord 5 from being detached from the bushing 4.

The covering of the cord 5 is stripped away at one end 5b (referred to as a cord end 5b, hereinafter) thereof so that core wires are exposed, as shown in FIG. 5. The core wires are electrically connected to terminals (not shown) of the speaker unit 11.

The ornament ring 9 is fit into the ring base 8, with the bushing 4 having been inserted into the tube 9b. The ornament ring 9 may be fixed to the ring base 8 by an adhesive.

The cover 10 has a bowl shape with an oval circumference corresponding to the ornament ring 9. The cover 10 is fit into the ring 9c of the ornament ring 9.

As shown in FIGS. 2, 7 and 9, the cover 10 is provided with a cutaway 10c along the longitudinal axis CL1. Through the cutaway 10c, a portion of tube 9b of the ornament ring 9 is exposed to the outside of the housing HG.

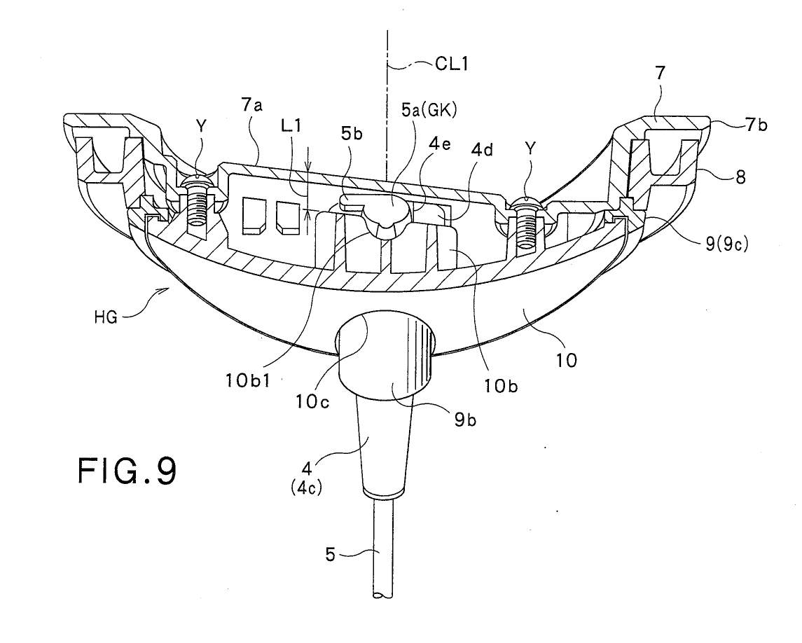

As shown in FIG. 9, the base 7 and the cover 10 are fixed to each other by a tapping screw Y, with the ring base 8 and the ornament ring 9 interposed therebetween. Shown in FIG. 9 are only two tapping screw Y, for brevity. Practically, the base 7 and the cover 10 are fixed to each other by three tapping screws Y, for example.

The housing HG has a roughly oval shape, as shown in FIGS. 1 and 2. Along the longitudinal axis CL1, a portion of the tube 9b of the ornament ring 9 is exposed to the outside of the housing HG. Moreover, the tapered tube 4c of the bushing 4 is exposed from the exposed tube 9b, with the cord 5 running outside along the longitudinal axis CL1.

The base 7, the ring base 8, the ornament ring 9, and the cover 10 are formed by resin molding using ABS (Acrylonitrile Butadiene Styrene) resin, for example. The ornament ring 9 is coated with chrome plating, for example. The bushing 4 is made of a flexible material, such as, silicon rubber.

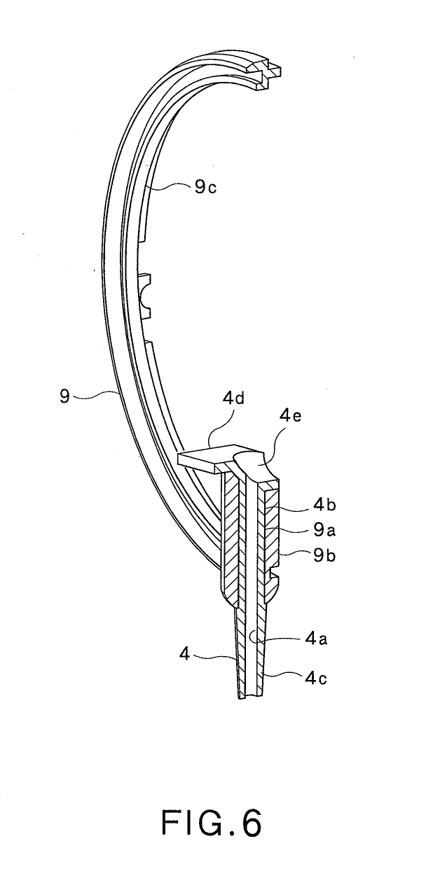

FIG. 6 is a perspective sectional view of the ornament ring 9 taken on line S1-S1 of FIG. 4. Illustrated in FIG. 6 is that the bushing 4 has been inserted into through hole 9a of the tube 9b of the ornament ring 9. The through hole 9a has an internal diameter roughly equal to or a little bit smaller than the outer diameter of the tube 4b of the bushing 4 so that bushing 4 can be tightly inserted into the through hole 9a with almost no gap.

The through hole 4a of the tube 4b of the bushing 4 has an internal diameter roughly equal to an outer diameter of the cord 5 so that the cord 5 can be tightly inserted into the through hole 4a with almost no gap.

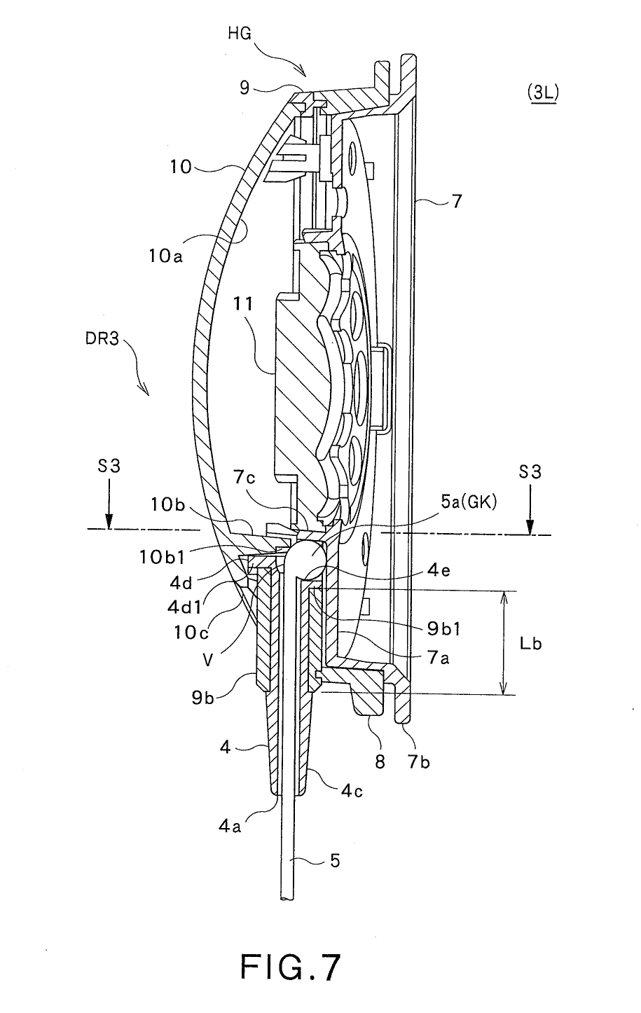

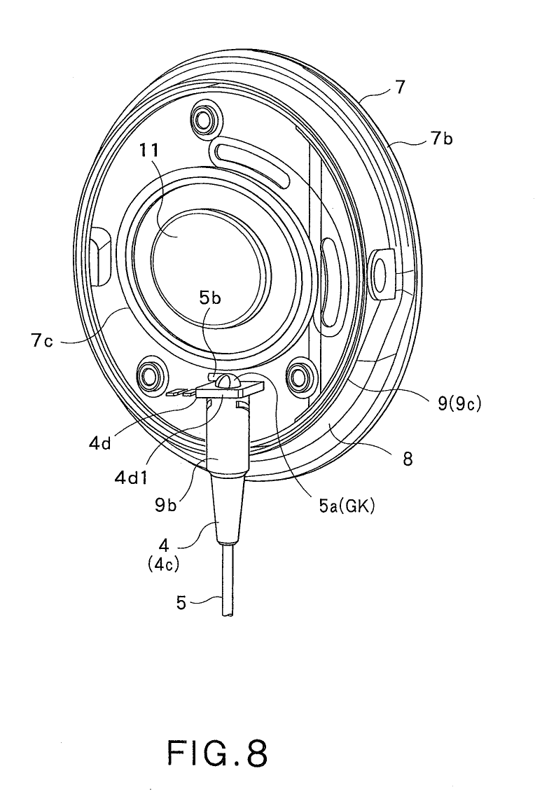

Described next in detail with respect to FIGS. 7 to 9 is a configuration of the main unit 3L. FIG. 7 is a sectional view of the main unit taken on line S2-S2 of FIG. 2 (line S2-S2 corresponding to the longitudinal axis of the oval shape of the base 7). FIG. 8 is a perspective view of the main unit 3L, without the cover 10 (detached therefrom). FIG. 9 is a perspective sectional view of the main unit 3L taken on line S3-S3 of FIG. 7 and viewed from a direction of an arrow DR3.

As shown in FIG. 7, the tube 4b of the bushing 4 is covered with the tube 9b of the ornament ring 9 at least within a distance Lb in the longitudinal direction, with the tapered tube 4c exposed to the outside of the main unit 3L. An end of the tube 9b closer to the speaker unit 11 is in contact with the flange 4d of the bushing 4. The tube 9b is provided with a cutaway 9b1 (FIG. 3) at a location that corresponds to the concavity 4e of the bushing 4 when the end of the tube 9b is in contact with the flange 4d. The cutaway 9b1 is formed into a shape that does not cover the concavity 4e.

The bushing 4 is located so that its flange 4d becomes closer to the rib 7c of the base 7 with respect to the longitudinal axis CL1.

As shown in FIG. 9, the cover 10 is provided with a rib 10b on an inner surface 10a thereof at the portion where the cord 5 is running to the outside, so as to straddle the longitudinal axis CL1. Provided on top of the rib 10b and almost at the center of the rib 10b is a gouged section 10b1 that has a curved shape when viewed from above and in cross section.

In FIG. 7, provided between the bushing 4 and the speaker unit 11 is a space V that is surrounded by the baffle board 7a, the rib 7c, the concavity 4e, the cutaway 9b1, and the gouged section 10b1. Put in the space V is the outer-shape expansion portion GK (knot 5a) of the cord 5. And, at least a portion of the outer-shape expansion portion GK is installed in the concavity 4e.

As shown in FIG. 9, a gap L1 is provided between the top of the rib 7c and the baffle board 7a. From the gap L1, the cord end 5b is running toward the speaker unit 11. The cord end 5b is one end of the cord 5 closer to the speaker unit 11 than to the outer-shape expansion portion GK. The cord end 5b is shown for its portion only in FIG. 9.

The cord end 5b of the cord 5 is running from the outer-shape expansion portion GK in a direction other than the longitudinal axis CL1, almost orthogonal to the longitudinal axis CL1 in FIG. 9.

In the embodiment, the bushing 4 through which the cord 5 is running lies along the longitudinal axis CL1.

The position of the knot 5a (the outer-shape expansion portion GK) is restricted by the surrounding parts as follows:

The position of an end of the knot 5a closer to the speaker unit 11 is restricted by the rib 7c of the base 7. The position of the side face of the knot 5a is restricted by the gouged section 10b1 and the concavity 4e. The position of the other end of the knot 5a closer to the bushing 4 is restricted by the concavity 4e.

The flange 4d of the bushing 4 is formed into a rectangle, which is a quadrilateral in this embodiment. One of the four sides of the rectangular flange 4d is in contact with the baffle board 7a so that the bushing 4 is prevented from rotating about the longitudinal axis CL1. Provided on the one side is the concavity 4e.

As shown in FIG. 7, the rectangular flange 4d of the bushing 4 has one side 4d1 that faces the one side of flange 4d described above. The side 4d1 is tightly interposed between the tube 9b of the ornament ring 9 and a rib 10b of the tube 9b with almost no gap so that the position of the bushing 4 along the longitudinal axis CL1 is restricted. This configuration prevents the bushing 4 from being pulled out by pulling the tapered tube 4c and also from moving with respect to the ornament ring 9.

The tube 4b of the bushing 4 is covered with the tube 9b of the ornament ring 9 within the distance Lb in the longitudinal direction so that it cannot be bent within the distance Lb. The distance Lb is determined in accordance with the material of the bushing 4.

Since a portion of the bushing 4 is covered with the tube 9b as described above, it is extremely rare that the bushing 4 is bent and torn, even though the bushing 4 is provided with the concavity 4e.

Moreover, the tapered tube 4c of the bushing 4 is exposed from the tube 9b of the ornament ring 9 so that it is bendable. The bendable tapered tube 4c gives high durability to the cord 5.

In the embodiment, the flange 4d of the bushing 4 is provided with the concavity 4e to give the space V for the outer-shape expansion portion GK (the knot 5a). This configuration allows the flange 4d of the bushing 4 to be closer to the speaker unit 11.

The cord end 5b of the cord 5 is running from the outer-shape expansion portion GK (the knot 5a) in a direction other than the longitudinal axis CL1, for example, orthogonal to the longitudinal axis CL1 in FIG. 9.

The longitudinal axis CL1 agrees with the longitudinal axis of the through hole 4a of the bushing 4 in the embodiment.

If the housing HG is formed into a configuration without the longitudinal axis CL1, it is preferable that the cord end 5b of the cord 5 is running in a direction away from the longitudinal axis of the through hole 4a of the bushing 4.

With the configuration described above, a larger speaker unit can be installed in a main unit having the same size as that of the known headphones, or, conversely, a smaller main unit can install a speaker unit having the same size as that of the known headphones.

In the embodiment, a portion of the tube 9b of the ornament ring 9 is exposed to the outside from the cover 10 so that the flange 4d of the bushing 4 is located closer to the inner periphery of the main unit 3L. This arrangement decreases the volume of the bushing 4 in the main unit 3L.

The decreased volume of the bushing in the main unit allows a larger speaker unit to be installed in a main unit having the same size as that of the known headphones, or, conversely, a smaller main unit to install a speaker unit having the same size as that of the known headphones.

Moreover, a larger internal spatial volume (a back cavity) can be given to the main unit even if the main unit and the speaker unit of the embodiment are formed to have the same size as those of the known headphones. Therefore, the headphone set 50 of the embodiment can reproduce sounds of a rich low tone.

The bushing 4 is made of a flexible material, such as, silicon rubber, and hence a user can enjoy its flexibility and softness.

Suppose that the headphone set 50 is configured to have the bushing 4 exposed to the outside of the housing HG not through the tube 9b of the ornament ring 9. In this case, there are many restrictions on design for a user so as not to feel the difference in material between the rubber of the bushing 4 and the resin of the cover 10 and other parts of the housing HG.

However, in this embodiment, the bushing 4 is exposed to the outside of the housing HG through the tube 9b of the ornament ring 9. Therefore, the color or coating of the ornament ring 9 can be changed freely so that a user does not feel the difference in material, which increases flexibility in design for the appearance of the headphone set 50.

It is further understood by those skilled in the art that the foregoing description is a preferred embodiment of the disclosed apparatus and that various changes and modifications may be made in the invention without departing from the sprit and scope thereof.

For example, the bushing 4 and the cord 5 may be running from the main units 3L and 3R in any direction that does not lie along the longitudinal axes of the main units 3L and 3R.

The headphone set 50 of the embodiment is an overhead type, equipped with the head band 1. Not only that, the present invention is applicable to an inner-ear type to be inserted into the auricle.

The tube 9b that supports the bushing 4 is not always necessary one of the parts of the ornament ring 9.

The outer-shape expansion portion GK of the cord 5 is not always necessary the knot 5a tied in the cord 5. It may be a protrusion formed by thermal welding or formed integral with the cord 5. The shape of the protrusion may be a rectangle, a polygon, a circle, a semi-circle sphere, and any other shape which has no particular name, when viewed from above.

As described above in detail, the present invention provides a headphone set equipped with a compact housing having an outer-shape expansion portion of a cord and a bushing for the cord, that exhibits high durability.

What is claimed is:

1. A headphone set comprising:
a housing having a pulling-out portion;
a speaker enclosed in the housing;
a cord having a first end and an opposing second end, the first end being connected to the speaker, the second end being running to the outside of the housing through the pulling-out portion;
a bushing formed into a tube having a first through hole, the bushing supporting the cord in a way that the cord is inserted into the first through hole at the pulling-out portion;
an outer-shape expansion portion fixed to the cord and located between the speaker and the bushing, the outer-shape expansion portion expanding the outer shape of the cord; and
a concavity provided to the bushing at one end of the bushing closer to the speaker, at least a portion of the outer-shape expansion portion being put in the concavity.

2. The headphone set according to claim 1 wherein the pulling-out portion has a tube having a second through hole, a portion of the bushing closer to the speaker being inserted into the second through hole.

3. The headphone set according to claim 1 wherein the speaker is located in a way that at least a portion of the speaker lies along an axis of the first through hole of the bushing with respect to the outer-shape expansion portion, the first end of the cord is running in a direction different from the axis of the first through hole.
